(19) United States
(12) Patent Application Publication
(10) Pub. No.: US 2024/0412317 A1
(43) Pub. Date: Dec. 12, 2024

(54) CONTROL SYSTEM, CONTROL METHOD, AND RECORDING MEDIUM

(71) Applicant: NEC Corporation, Minato-ku, Tokyo (JP)

(72) Inventors: Kazuaki NAKAJIMA, Tokyo (JP); Io FURUYAMA, Tokyo (JP)

(73) Assignee: NEC Corporation, Mintao-ku, Tokyo (JP)

(21) Appl. No.: 18/697,078

(22) PCT Filed: Nov. 9, 2021
(86) PCT No.: PCT/JP2021/041075

§ 371 Date: Mar. 29, 2024

(51) Int. Cl. G06Q 50/26

(52) U.S. Cl. CPC G06Q 50/265

(57) ABSTRACT

This control system comprises a shared information reception unit and a control unit. The shared information reception unit receives destination information indicating a destination, permission/prohibition information indicating whether to permit or prohibit disclosure to parties other than the destination, and shared information. The control unit controls whether to disclose the shared information. Upon receiving a request to disclose the shared information from a requesting party other than the destination, the control unit allows the shared information to be disclosed to the requesting party if the disclosure is permitted, or prohibits the shared information from being disclosed to the requesting party if the disclosure is prohibited.

### TECHNICAL FIELD

The present disclosure relates to a control system and the like.

### BACKGROUND ART

There is a case where it is desired to share various types of information with another user, another organization, another device, or the like.

For example, PTL 1 discloses a technique of performing control to permit use of information when receiving information in which control information for permitting use of information is set, and performing control to permit transfer of information when receiving information in which control information for permitting transfer of information is set. Specifically, for example, PTL 1 describes that a reliability is added to personal information of each member, and the reliability is used to determine whether to permit primary use or secondary use.

### CITATION LIST

### Patent Literature

PTL 1: WO 2011/021278 A1

### SUMMARY OF INVENTION

### Technical Problem

For example, in a case where the user allows various types of information to be shared with other users, other organizations, or the like, the information is shared with a designated destination, and the information is not shared with a place other than the designated destination. In a case where the information is shared with a place other than the designated destination, the user may set a right of access to the information to another user each time the information is shared with another user. As described above, there is a problem that it takes time and effort for the user.

An example of an object of the present disclosure is to provide a control system and the like that can save the user's trouble when sharing information.

### Solution to Problem

A control system according to an aspect of the present disclosure includes a shared information reception means configured to receive destination information indicating a destination, allowability information indicating allowability of disclosure to a requester other than the destination, and shared information, and a control means configured to control whether to disclose the shared information, wherein when receiving a disclosure request for disclosing the shared information from a requester other than the destination, the control means discloses the shared information to the requester in a case where the disclosure is allowed, and does not disclose the shared information to the requester in a case where the disclosure is not allowed.

A control method according to an aspect of the present disclosure includes receiving destination information indicating a destination, allowability information indicating allowability of disclosure to a requester other than the destination, and shared information, and controlling whether to disclose the shared information, wherein when receiving a disclosure request for disclosing the shared information from a requester other than the destination, the controlling includes disclosing the shared information to the requester in a case where the disclosure is allowed, and not disclosing the shared information to the requester in a case where the disclosure is not allowed.

A program according to an aspect of the present disclosure causes a computer to execute the steps of receiving destination information indicating a destination, allowability information indicating allowability of disclosure to a requester other than the destination, and shared information, and controlling whether to disclose the shared information, wherein when receiving a disclosure request for disclosing the shared information from a requester other than the destination, the controlling step includes disclosing the shared information to the requester in a case where the disclosure is allowed, and not disclosing the shared information to the requester in a case where the disclosure is not allowed.

The program may be stored in a non-transitory computer-readable recording medium.

### Advantageous Effects of Invention

According to the present disclosure, it is possible to save the user's trouble of sharing information.

### BRIEF DESCRIPTION OF DRAWINGS

FIG. 1 is a block diagram illustrating a configuration example of a control system according to the first example embodiment.

FIG. 2 is a flowchart illustrating an operation example of the control system according to the first example embodiment.

FIG. 3 is an explanatory diagram illustrating an example of connection between a control system and a terminal device according to a second example embodiment.

FIG. 4 is a block diagram illustrating a configuration example of the control system according to the second example embodiment.

FIG. 5 is an explanatory diagram illustrating an example of reception data.

FIG. 6 depicts an explanatory diagram (part 1) illustrating an example of receiving a request for disclosing shared information.

FIG. 7 depicts an explanatory diagram (part 2) illustrating an example of receiving a request for disclosing shared information.

FIG. 8 depicts an explanatory diagram illustrating an example of setting a disclosure range of an SBOM.

FIG. 9 is an explanatory diagram illustrating another example of reception data.

FIG. 10 is an explanatory diagram illustrating an example in which alert information is disclosed after a predetermined time has elapsed.

FIG. 11 is a flowchart illustrating an operation example at the time of receiving shared information of the control system according to the second example embodiment.

FIG. 12 is a flowchart illustrating an operation example at the time of receiving a request for disclosing the control system according to the second example embodiment.

FIG. 13 is an explanatory diagram illustrating a hardware configuration example of a computer device.

### EXAMPLE EMBODIMENT

Hereinafter, example embodiments of a control system, a control method, a program, and a non-transitory recording medium recording the program according to the present disclosure will be described in detail with reference to the drawings. The present example embodiment does not limit the disclosed technology.

### First Example Embodiment

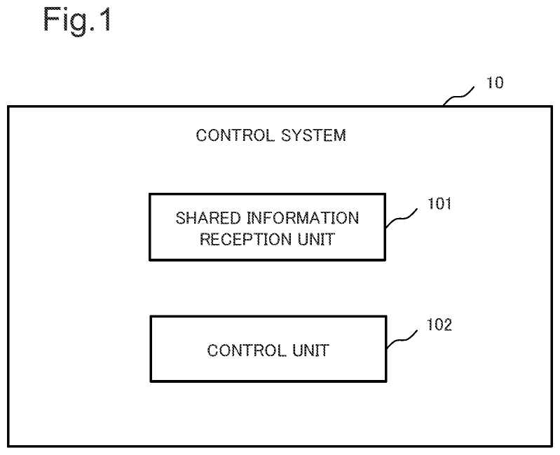

First, in the first example embodiment, a basic function of the control system will be described. FIG. 1 is a block diagram illustrating a configuration example of a control system according to the first example embodiment. A control system 10 controls disclosure of the shared information. The control system 10 includes a shared information reception unit 101 and a control unit 102.

The shared information reception unit 101 receives the destination information, the allowability information, and the shared information. Specifically, for example, the shared information reception unit 101 receives reception data in which the destination information, the allowability information, and the shared information are associated with each other. The destination information and the allowability information are, for example, header information of the shared information.

The destination information indicates a destination of the shared information. The destination may be, for example, one or more users, one or more terminal devices, or a combination thereof. The allowability information indicates allowability of disclosure of the shared information to a requester other than the destination.

The shared information is information shared by the destination. That is, when receiving the request for disclosing the shared information from the destination, the control system 10 discloses the shared information to the destination. The shared information may be, for example, security information. The security information is shared with the destination, and may be disclosed to a requester other than the destination in some cases, or may not be disclosed to a requester other than the destination in some cases. For example, the security information is confidential information or the like having confidentiality. More specifically, examples of the security information include information necessary for constructing a supply chain relationship such as a software bill of materials (SBOM), risk assessment information, alert information, and the like. The risk assessment information is, for example, results of various inspections and analyses. An inspection or analysis target is a specific device or the like, and is not particularly limited. The alert information may be, for example, an alert for making a notification that a cyberattack is being received, an alert indicating that a vulnerability for which a resolution means is not provided is included, an alert at the time of disaster such as fire or flood damage, or the alert is not particularly limited. The target subjected to the cyberattack is a specific device or the like, and is not particularly limited. The target including the vulnerability for which the resolution means is not provided is a specific device or the like, and is not particularly limited.

When receiving a request for disclosing the shared information from a requester other than the destination, the control unit 102 discloses the shared information to the requester in a case where the disclosure is allowed. As a result, the requester may access the shared information, or the control system 100 may transmit the shared information to the requester. On the other hand, in a case where the disclosure is not allowed, the control unit 102 does not disclose the shared information to the requester. As a result, the requester cannot access the shared information, or the control system 100 does not transmit the shared information to the requester.

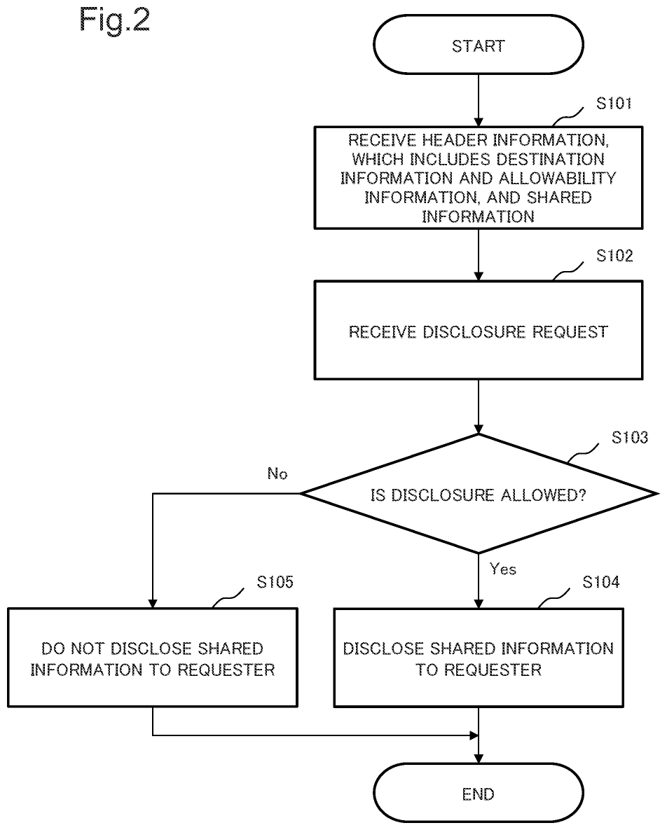

FIG. 2 is a flowchart illustrating an operation example of the control system 10 according to the first example embodiment. The shared information reception unit 101 receives the header information, which includes the destination information and the allowability information, and the shared information (step S101). The control unit 102 receives the request for disclosing the shared information from a requester other than the destination (step S102). Next, the control unit 102 determines whether the disclosure of the shared information is allowed (step S103). In a case where the allowability information of the shared information indicates the disclosure is allowed (step S103: Yes), the control unit 102 discloses the shared information to the requester (step S104). In a case where the allowability information indicates the disclosure is not allowed (step S103: No), the control unit 102 does not disclose the shared information to the requester (step S105).

As described above, in the first example embodiment, the control system 10 receives the shared information together with the allowability information indicating whether to allow disclosure to a requester other than the destination. Then, when receiving the disclosure request from a requester other than the destination, the control system 10 discloses the shared information to the requester in a case where the allowability information indicates that the disclosure is allowed, and does not disclose the shared information to the requester in a case where the allowability information indicates that the disclosure is not allowed. As a result, since whether to disclose the shared information is controlled by the allowability information, it is possible to save the user's trouble when sharing the shared information. It is possible to suppress occurrence of a change mistake such as a wrong access setting, and to enable appropriate access control.

The first example embodiment is not limited to the example described above, and various modifications can be made.

### Second Example Embodiment

Next, the second example embodiment will be described in detail with reference to the drawings. In the second example embodiment, an example in which a control system registers various types of shared information created by a terminal device in a database and controls disclosure of the shared information registered in the database will be described. Hereinafter, description of details overlapping with the above description will be omitted to the extent that the description of the second example embodiment is not unclear.

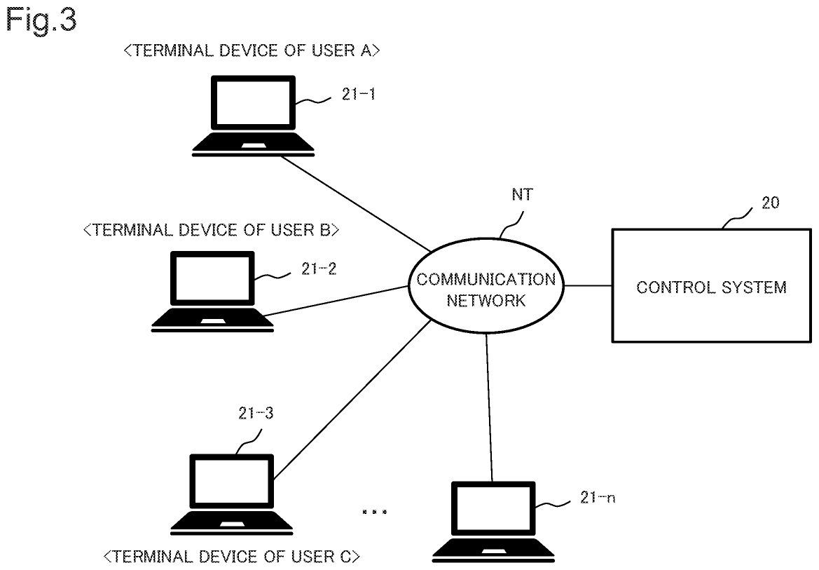

FIG. 3 is an explanatory diagram illustrating an example of connection between a control system and a terminal device according to the second example embodiment. A control system 20 is connected to each terminal device 21 via a communication network NT.

The control system 20 may be, for example, a server. The control system 20 is, for example, a shared base shared by a plurality of terminal devices 21 or a shared base used by each user who uses the terminal device 21. The terminal device 21 is not particularly limited, and examples of the terminal device 21 include a personal computer (PC), a smartphone, a tablet type device, and an Internet of Things (IoT) device.

In FIG. 3, there are a terminal device 21-1 of a user A, a terminal device 21-2 of a user B, a terminal device 21-3 of a user C, and a terminal device 21-n. n is not particularly limited, that is, the number of terminal devices 21 is not particularly limited. In the following description, in a case where the terminal device is not limited to any one of the terminal devices, the terminal device is referred to as the terminal device 21. In FIG. 3, the terminal device 21 is allocated to each user, but the present invention is not limited thereto. For example, a plurality of users may switch and use one terminal device 21, or the terminal device 21 may not be allocated to the user.

For example, a specific application program using the control system 20 may be installed in the terminal device 21. The terminal device 21 may transmit and receive various types of information to and from the control system 20 via a specific application program. Alternatively, the terminal device 21 may be able to access the control system 20 via a web browser or the like. The terminal device 21 may transmit and receive various types of information to and from the control system 20 via a web browser or the like.

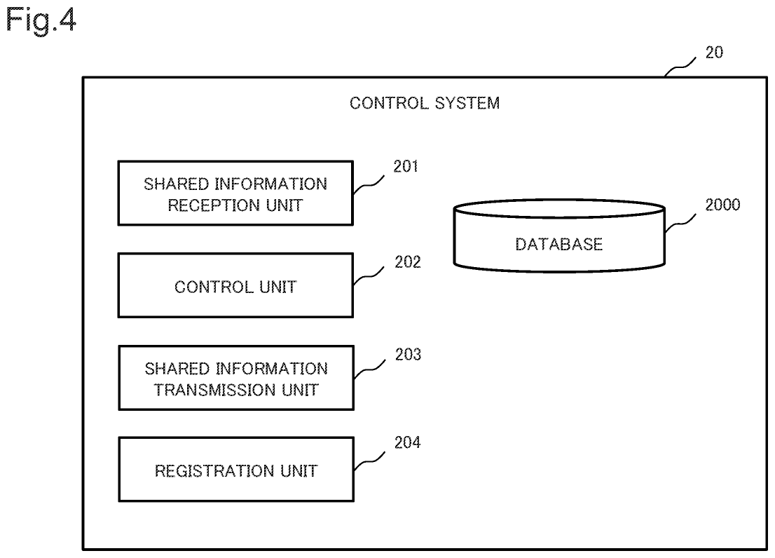

FIG. 4 is a block diagram illustrating a configuration example of the control system 20 according to the second example embodiment. The control system 20 includes a shared information reception unit 201, a control unit 202, a shared information transmission unit 203, and a registration unit 204. In control system 20 according to the second example embodiment, the shared information transmission unit 203 and the registration unit 204 are newly added to the first example embodiment. The shared information reception unit 201 and the control unit 202 have the basic functions of the shared information reception unit 101 and the control unit 102 described in the first example embodiment, respectively.

The control system 20 includes a database 2000. For example, reception data including shared information is registered in the database 2000. The database 2000 may be operated using, for example, a structured query language (SQL) or the like. The database 2000 may be stored in the control system 20, or may be stored in another device (for example, a database server or the like) accessible by the control system 20 via the communication network NT or the like.

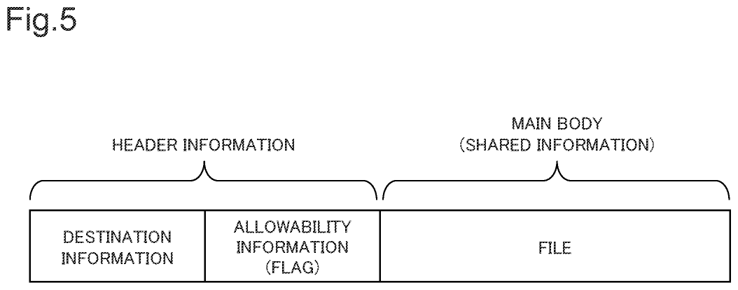

The shared information reception unit 201 receives the destination information, the allowability information, and the shared information. The reception data including the destination information, the allowability information, and the shared information will be described with reference to FIG. 5.

FIG. 5 is an explanatory diagram illustrating an example of reception data. In FIG. 5, the reception data includes the header information and the shared information. As described above, the header information includes the destination information and the allowability information.

The allowability information indicates, for example, allowability of whether the shared information is disclosed to a requester other than the destination. For example, the allowability information may be a flag indicating allowability of disclosure. More specifically, for example, the allowability information may be a flag in which 0 indicates the disclosure is allowed and I indicates the disclosure is not allowed.

The order of each piece of information in the header information is not particularly limited. The header information may include other information such as the transmission source information indicating a transmission source, the transmission date and time information indicating a transmission date and time, and the like.

Next, returning to the description of FIG. 4, the registration unit 204 registers the destination information, the allowability information, and the shared information in the database 2000 in association with each other. The registration unit 204 may register other information included in the header information in the database 2000 in association with the destination information, the allowability information, and the shared information.

Then, the shared information transmission unit 203 transmits the shared information to the destination indicated by the destination information. The order of the timing at which the registration unit 204 registers the reception data in the database 2000 and the timing at which the shared information transmission unit 203 transmits the shared information to the destination is not particularly limited.

The shared information transmission unit 203 transmits each piece of shared information to the requester of the disclosure request under the control of the control unit 202.

The control unit 202 controls whether to disclose the shared information. For example, when receiving a request for disclosing the shared information from a requester other than the destination, the control unit 202 disclose the shared information to the requester in a case where the disclosure is allowed, and does not disclose the shared information to the requester in a case where the disclosure is not allowed. Specifically, for example, in a case where the disclosure is allowed, the control unit 202 causes the shared information transmission unit 203 to transmit the shared information to the requester. For example, in a case where the disclosure is allowed, the shared information transmission unit 203 detects the shared information from the database 2000 to transmit the detected shared information to the requester. On the other hand, for example, the control unit 202 does not cause the shared information transmission unit 203 to transmit the shared information to the requester in a case where the disclosure is not allowed. In a case where the disclosure is not allowed, the control unit 202 causes the shared information transmission unit 203 to transmit information indicating that the disclosure is not allowed to the requester. The shared information transmission unit 203 may transmit information indicating that the disclosure is not allowed to the requester. The information indicating that the disclosure is not allowed is not particularly limited. For example, the information indicating that the disclosure is not allowed may be information for causing the requester to display that the disclosure is not allowed.

In a case where the disclosure request is received from the destination of the shared information, the control unit 202 disclose the shared information to the destination (requester). The shared information transmission unit 203 transmits the shared information to the destination (requester).

In a case where a disclosure request is received from a transmission source (creation source) of the shared information, the control unit 202 disclose the shared information to the destination (requester). Specifically, for example, when receiving a disclosure request from the transmission source (creation source) of the shared information, the control unit 202 causes the shared information transmission unit 203 to transmit the shared information to the destination (requester). Then, for example, the shared information transmission unit 203 transmits the shared information to the transmission source (creation source). In the database 2000, transmission source information indicating a transmission source may be registered in association with the shared information.

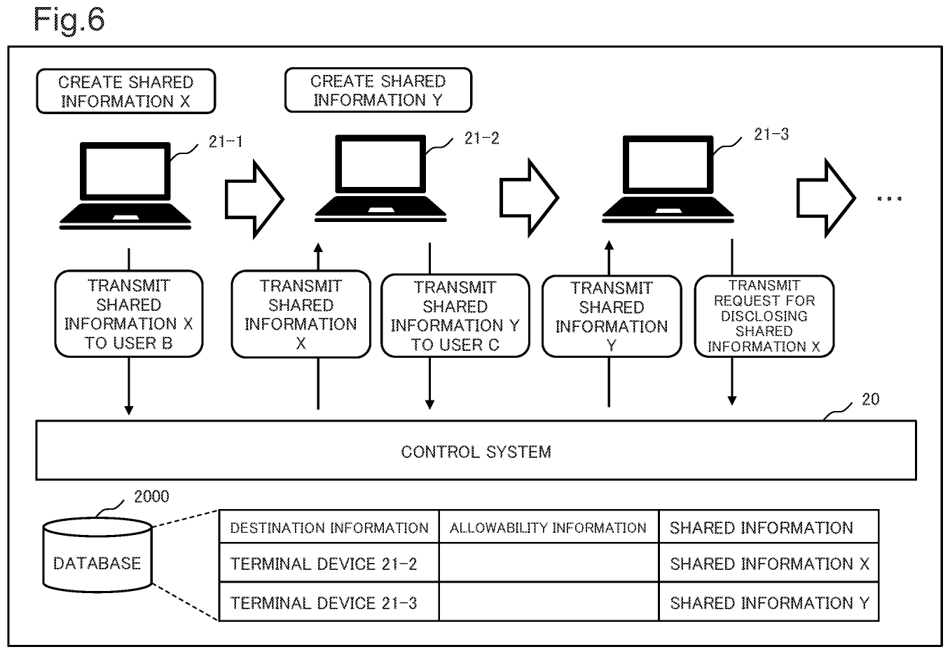

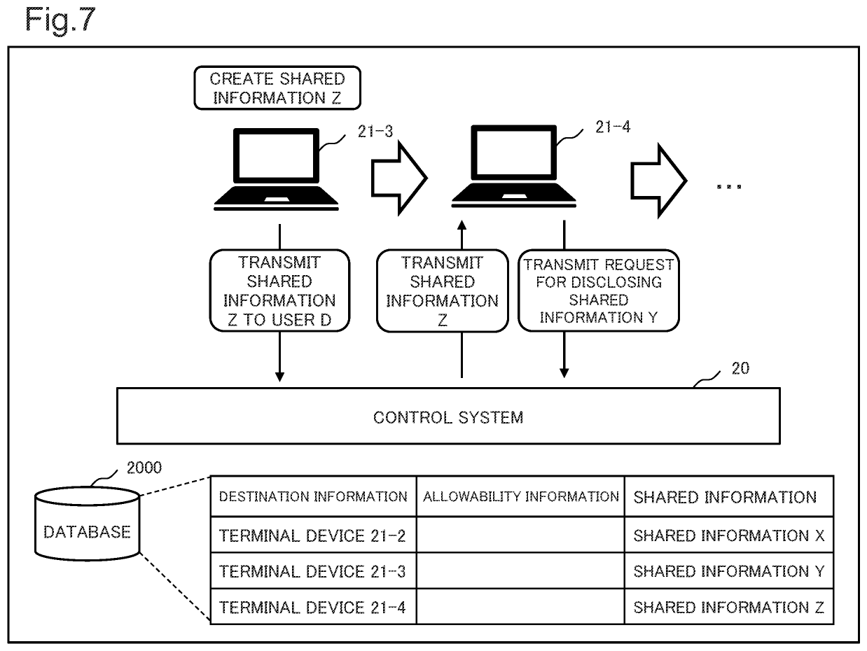

Next, with reference to FIGS. 6 and 7, an example of, in a case where there is a flow of data in such a way that information created by a certain user is referred to by the next user, such as a supply chain, whether disclose of each piece of shared information is allowed in a case where the shared information created in the upstream terminal device 21 is referred to by the shared information created in the downstream terminal device 21 will be described.

FIG. 6 is an explanatory diagram (part 1) illustrating an example of receiving a request for disclosing shared information. In FIG. 6, the terminal device 21-1 creates shared information X by the operation of the user A. Then, the terminal device 21-1 transmits the shared information X to the control system 20 with the destination information and the allowability information as header information according to the operation by the user A. A case where the destination indicated by the destination information is the terminal device 21-2 of the user B will be described as an example.

The shared information reception unit 201 receives the destination information, the allowability information, and the shared information X. The registration unit 204 registers the destination information, the allowability information, and the shared information X in the database 2000 in association with each other.

The shared information transmission unit 203 transmits the shared information X to the terminal device 21-2 of the user B as the destination indicated by the destination information.

Next, the terminal device 21-2 of the user B receives the shared information X from the control system 20. Since the terminal device 21-2 is a destination, it can refer to the shared information X. Then, the terminal device 21-2 creates shared information Y including link information indicating an access destination for accessing the shared information X according to the operation by the user B. Then, the terminal device 21-2 transmits the shared information Y to the control system 20 with the destination information and the allowability information as header information according to the operation by the user B. A case where the destination indicated by the destination information is the terminal device 21-3 of the user C will be described as an example.

Then, the terminal device 21-3 of the user C receives the shared information Y from the control system 20. Since the shared information Y includes the link information of the shared information X, the terminal device 21-3 transmits a request for disclosing the shared information X to the control system 20 based on the link information, for example.

First, a case where the allowability information of the shared information X indicates the disclosure is allowed will be described. When receiving the disclosure request from the terminal device 21-3 of the user C who is not the destination of the shared information X, the control unit 202 refers to the allowability information of the shared information X from the database 2000. Since the allowability information indicates the disclosure is allowed, the control unit 202 disclose the shared information X to the terminal device 21-3. Specifically, for example, the control unit 202 causes the shared information transmission unit 203 to transmit the shared information X to the terminal device 21-3 since the allowability information indicates the disclosure is allowed. Then, for example, the shared information transmission unit 203 transmits the shared information X to the terminal device 21-3.

On the other hand, a case where the allowability information of the shared information X indicates the disclosure is not allowed will be described. When receiving the disclosure request from the terminal device 21-3 of the user C who is not the destination of the shared information X, the control unit 202 refers to the allowability information of the shared information X from the database 2000. Since the allowability information indicates the disclosure is not allowed, the control unit 202 does not disclose the shared information X to the terminal device 21-3. Specifically, for example, the control unit 202 does not cause the shared information transmission unit 203 to transmit the shared information X to the terminal device 21-3 since the allowability information indicates the disclosure is not allowed. Therefore, the shared information transmission unit 203 does not transmit the shared information X to the terminal device 21-3. For example, since the allowability information indicates the disclosure is not allowed, the control unit 202 may cause the shared information transmission unit 203 to transmit information indicating the disclosure is not allowed to the terminal device 21-3. Then, the shared information transmission unit 203 may transmit information indicating that the disclosure is not allowed to the terminal device 21-3.

FIG. 7 is an explanatory diagram (part 2) illustrating an example of receiving a request for disclosing shared information. In FIG. 7, next to FIG. 6, the terminal device 21-3 of the user C creates shared information Z including link information indicating an access destination for accessing shared information Y, for example, according to the operation by the user C. Then, the terminal device 21-3 transmits the shared information Z to the control system 20 with the destination information and the allowability information as header information according to the operation by the user C. A case where the destination indicated by the destination information is the terminal device 21-4 of a user D will be described as an example.

Then, the terminal device 21-4 of the user D receives the shared information Z from the control system 20. Since the shared information Z includes the link information of the shared information Y, the terminal device 21-4 transmits a request for disclosing the shared information Y to the control system 20 based on the link information, for example.

First, a case where the allowability information of the shared information Y indicates the disclosure is allowed will be described. When receiving the disclosure request from the terminal device 21-4 of the user D that is not the destination of the shared information Y, the control unit 202 refers to the allowability information of the shared information Y from the database 2000. Since the allowability information indicates the disclosure is allowed, the control unit 202 disclose the shared information Y to the terminal device 21-4. The control unit 202 causes the shared information transmission unit 203 to transmit the shared information Y to the terminal device 21-4 since the allowability information indicates the disclosure is allowed. Therefore, the shared information transmission unit 203 transmits the shared information Y to the terminal device 21-4. As a result, the terminal device 21-4 receives the shared information Y from the control system 20. Since the shared information Y includes the link information of the shared information Z, the terminal device 21-4 transmits a request for disclosing the shared information X to the control system 20 based on the link information, for example. The subsequent processing is as described with reference to FIG. 6. Therefore, in a case where the allowability information of the shared information X indicates the disclosure is allowed, the shared information X is disclosed to the terminal device 21-4. In a case where the allowability information of the shared information X indicates the disclosure is not allowed, the shared information X is not disclosed to the terminal device 21-4.

On the other hand, a case where the allowability information of the shared information Y indicates the disclosure is not allowed will be described. When receiving the disclosure request from the terminal device 21-4 of the user D that is not the destination of the shared information Y, the control unit 202 refers to the allowability information of the shared information Y from the database 2000. Since the allowability information indicates the disclosure is not allowed, the control unit 202 does not disclose the shared information Y to the terminal device 21-4.

Specifically, for example, since the allowability information indicates the disclosure is not allowed, the control unit 202 does not cause the shared information transmission unit 203 to transmit the shared information Y to the terminal device 21-4. Therefore, the shared information transmission unit 203 does not transmit the shared information Y to the terminal device 21-4. Alternatively, for example, since the allowability information indicates the disclosure is not allowed, the control unit 202 may cause the shared information transmission unit 203 to transmit information indicating the disclosure is not allowed to the terminal device 21-4. As a result, for example, the shared information transmission unit 203 transmits information indicating that the disclosure is not allowed to the terminal device 21-4. Therefore, since the shared information Y including the link information of the shared information X is not disclosed to the terminal device 21-4, the shared information X is not disclosed to the terminal device 21-4 via the shared information Y even in a case where the allowability information of the shared information X indicates the disclosure is allowed.

In this manner, the user can collectively set the disclosure range by the allowability information for the shared information. Therefore, in a case where the shared information created in the upstream terminal device 21 is referred to by the downstream terminal device 21, it is not necessary to set the disclosure range and the like for the downstream terminal device 21 each time, and it is possible to collectively set whether the disclosure is allowed. Therefore, it is possible to save the user's trouble of creating the shared information.

Next, a usage example of the control system 20 will be described using a specific example of the shared information.

### <SBOM>

A usage example of the control system 20 will be described using a case where the shared information is the SBOM as an example. When an application program is developed, a plurality of pieces of software included in each application program may be developed by different companies or developers.

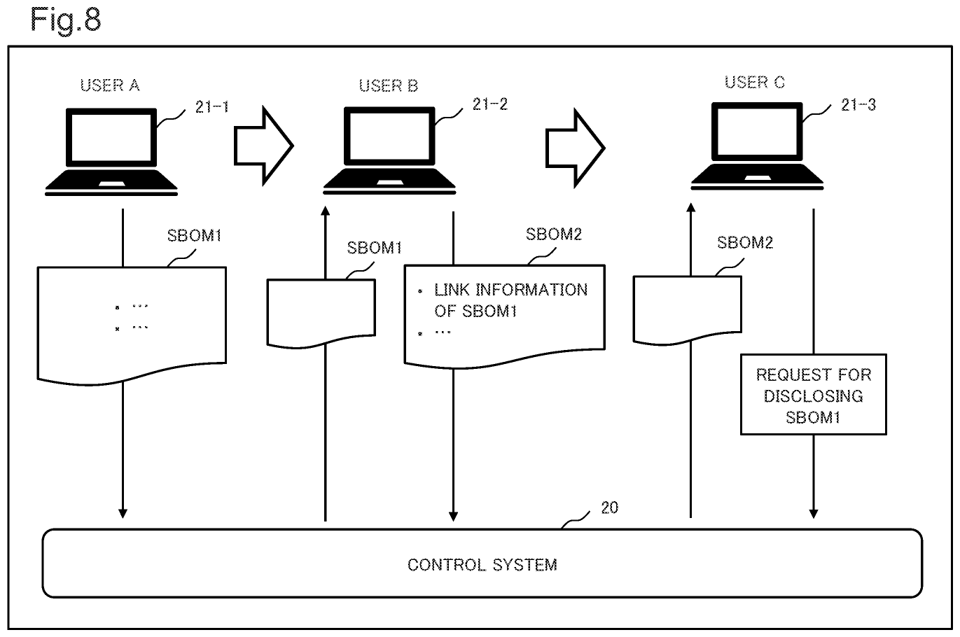

FIG. 8 is an explanatory diagram illustrating a setting example of the disclosure range of the SBOM. As in the supply chain, there is a case where the user A creates software and the user B creates another software with reference to the created software.

For example, there is a case where the user A discloses an SBOM1 of the software designed by the user A to the user B who is the delivery destination of the software, but does not want to disclose the SBOM1 to other users. In such a case, the terminal device 21-1 may transmit the SBOM1 to the control system 20 according to the operation by the user A with the allowability information indicating the disclosure is not allowed and the destination information indicating the user B as the destination as the header information.

Then, the shared information reception unit 201 receives the SBOM1. The registration unit 204 registers the header information and the SBOM1 in the database 2000 in association with each other. the shared information transmission unit 203 transmits the SBOM1 to the user B. The terminal device 21-2 of the user B receives the SBOM1. For example, the terminal device 21-2 creates an SBOM2 including the link information of the SBOM1 according to the operation by the user B. The terminal device 21-2 may transmit the SBOM2 to the control system 20 with the destination information indicating the user C as a destination as header information.

The shared information reception unit 201 receives the SBOM2. The registration unit 204 registers the header information and the SBOM2 in the database 2000 in association with each other. The shared information transmission unit 203 transmits the SBOM2 to the user C. The terminal device 21-3 of the user C receives the SBOM2. For example, the terminal device 21-3 transmits a request for disclosing the SBOM1 to the control system 20 based on the link information of the SBOM1 included in the SBOM2. When receiving the request for disclosing the SBOM1 from the user C, the control unit 202 does not disclose the SBOM1 to the user C since the allowability information associated with the SBOM1 included in the database 2000 indicates the disclosure is not allowed.

On the other hand, for example, there is a case where software designed by the user A is open source. In such a case, the user A may disclose the software not only to the user B as the delivery destination but also to other users. In such a case, the terminal device 21-1 may transmit the SBOM1 to the control system 20 according to the operation by the user A with the allowability information indicating the disclosure is allowed and the destination information indicating the user B as the destination as the header information. The subsequent processing is the same as that in the example described with reference to FIGS. 6 and 7, and thus a detailed description of the processing will be omitted.

### <Risk Assessment Information (Inspection Information)>

Next, a usage example of the control system 20 will be described using a case where the shared information is risk assessment information as an example. For example, risk assessment information may be obtained as a result of evaluating a certain component. Generally, the risk assessment information is shared with a delivery destination such as a requester of evaluation, but is not shared with other parties. However, depending on the component, the risk assessment information may be shared with the end user. The terminal device 21 may transmit the risk assessment information to the control system 20 with the allowability information indicating the disclosure is allowed and the destination information in which the delivery destination is the destination as the header information. On the other hand, in the case of non-sharing, the terminal device 21 may transmit the risk assessment information to the control system 20 with the allowability information indicating the disclosure is not allowed and the destination information in which the delivery destination is the destination as the header information.

The processing of the control system 20 is the same as that in the example described with reference to FIGS. 6 and 7, and thus detailed description of the processing is omitted.

### <Alert Information>

Next, a usage example of the control system 20 will be described using a case where the shared information is the alert information as an example. When a cyberattack or a disaster occurs, the alert information may be transmitted. The alert information may be disclosed to a requester other than the destination in some cases, or may be better not disclosed to a requester other than the destination in some cases. In a case where the alert information may be shared, the terminal device 21 may transmit the risk assessment information to the control system 20 with the allowability information indicating the disclosure is allowed and the destination information as header information. On the other hand, in a case where it is better that the alert information is not shared, the terminal device 21 may transmit the risk assessment information to the control system 20 with the allowability information indicating the disclosure is not allowed and the destination information as header information.

The processing of the control system 20 is the same as that in the example described with reference to FIGS. 6 and 7, and thus detailed description of the processing is omitted.

This is the end of the description of the usage example for each detailed information.

### <Control of Disclosure Over Time>

An example will be described in which, in a case where disclosure of the shared information is not allowed, control is performed in such a way that the information is disclosed as time passes. Even when disclosure of the shared information is not allowed, the information may be disclosed as time passes. For example, such control may be performed in a case where information with which vulnerability being present in a specific device can be identified is the shared information. The information with which vulnerability can be identified is not particularly limited to alert information and risk assessment information. The type of the specific device may be the terminal device 21 or is not particularly limited.

For example, in a case where the alert information indicates that a cyberattack occurs on a certain device, it is not desirable that the alert information is disclosed to various users while the cyberattack occurs. For example, when the fact that a device is subjected to a cyberattack is disclosed a malicious user, the malicious user may perform another cyberattack on the device. On the other hand, when the alert information is not disclosed after the problem is solved, for example, after the termination of the cyberattack, other users may have an impression that the fact that there has been the cyberattack is hidden. As in the risk assessment information, it is not desirable that the fact that a specific device is in a risk is disclosed to various users. On the other hand, in a case where there is no risk, it may be better to disclose what kind of risk has been present to other users.

Therefore, in a case where the disclosure is not allowed, when receiving the disclosure request, the control unit 202 controls whether to disclose the shared information to the requester to depending on the lapse of time from the reception of the shared information. Specifically, for example, in a case where the disclosure is not allowed, when receiving the disclosure request, the control unit 202 may not disclose the shared information to the requester of the disclosure request until a predetermined time elapses from the reception of the shared information, and may disclose the shared information to the requester of the disclosure request after the predetermined time elapses. The predetermined time may be a time designated by the user or may be a predetermined fixed value, and is not particularly limited. The fixed value may be determined according to the type of the shared information. For example, the predetermined time may be designated by the transmission source (or creation source) of the shared information. In a case where the transmission source designates a predetermined time, for example, time information indicating the predetermined time may be included in the header information of the shared information.

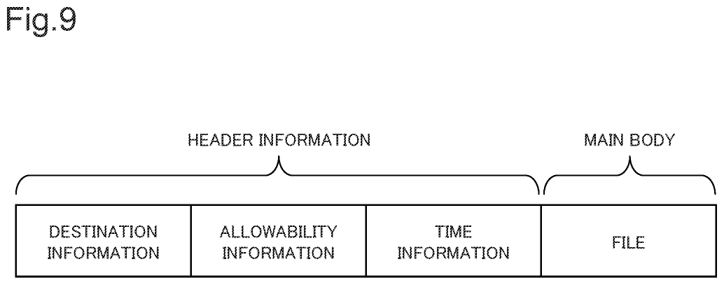

FIG. 9 is an explanatory diagram illustrating another example of the reception data. In FIG. 9, the reception data includes the header information and the shared information. The header information includes the destination information, the allowability information, and the time information. The destination information and the allowability information are as described in FIG. 5. The time information indicates a predetermined time. The order of each piece of information in the header information is not particularly limited. The header information may include other information such as the transmission source information indicating a transmission source, the date and time information indicating a transmitted date and time, and the like.

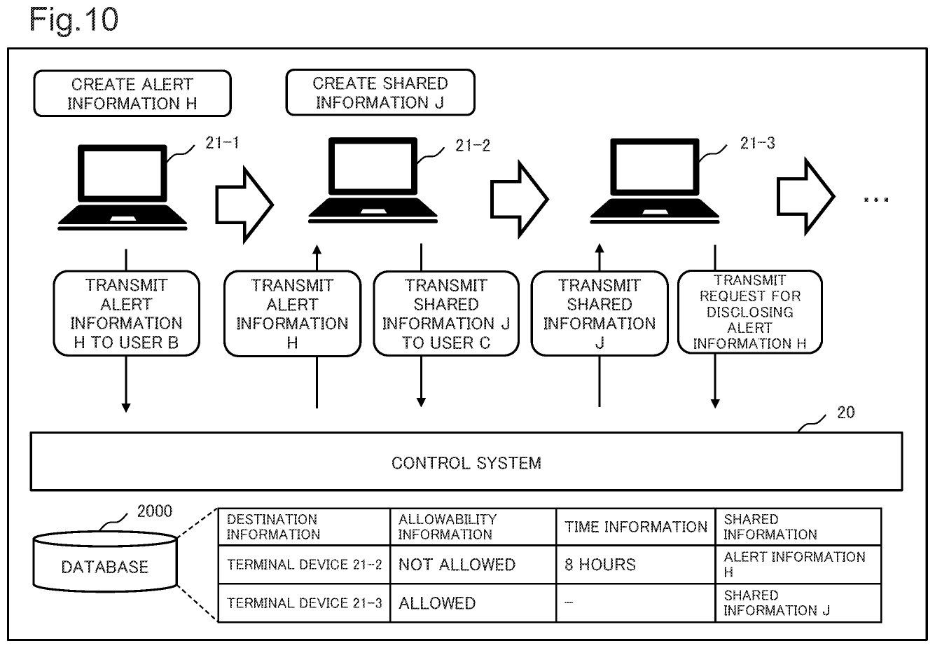

FIG. 10 is an explanatory diagram illustrating an example in which the alert information is disclosed after a predetermined time elapses. In FIG. 10, for example, when detecting the cyberattack, the terminal device 21-1 creates alert information H.

The terminal device 21-1 transmits alert information H to the control system 20 with, as header information, the destination information in which the destination is the user B, the allowability information indicating the disclosure is not allowed, and the time information indicating 8 hours. The shared information reception unit 201 of the control system 20 receives the reception data. Then, the registration unit 204 registers the reception data in the database 2000.

The shared information transmission unit 203 transmits the alert information H to the user B. The terminal device 21-2 of the user B creates the shared information J including the link information of the alert information H. The terminal device 21-2 transmits shared information J to the control system 20 with, as header information, the destination information in which the destination is the user C and the allowability information indicating the disclosure is allowed. The shared information reception unit 201 of the control system 20 receives the reception data. Then, the registration unit 204 registers the reception data in the database 2000. The shared information transmission unit 203 transmits the shared information J to the user C.

The terminal device 21-3 of the user C transmits a request for disclosing the alert information H to the control system 20 based on the link information included in the shared information J. When receiving the request for disclosing the alert information H, the control unit 202 refers to the allowability information and the time information of the alert information H from the database 2000. Since the allowability information of the alert information H indicates the disclosure is not allowed and the time information indicates 8 hours, the control unit 202 discloses the alert information H to the user C in a case where 8 hours have elapsed since the alert information H was received, and does not disclose the alert information H to the user C in a case where 8 hours have not elapsed since the alert information H was received. The transmission processing by the shared information transmission unit 203 is the same as that in the above-described example, and thus detailed description of the processing will be omitted.

The present invention is not limited to the example in which the control unit 202 determines whether a predetermined time has elapsed since the date and time when the shared information reception unit 201 received the shared information, and the control unit 202 may determine whether a predetermined time has elapsed since the date and time when the transmission source transmitted the shared information. Thus, the start date and time for determining the lapse of time is not particularly limited.

In a case where the disclosure is not allowed, when receiving the disclosure request, the control unit 202 may control whether to disclose the shared information to the requester according to whether it is a time after the designated time. For example, the time may be designated by a transmission source of the shared information. For example, the header information of the shared information may include time information indicating the designated time.

### Operation Example

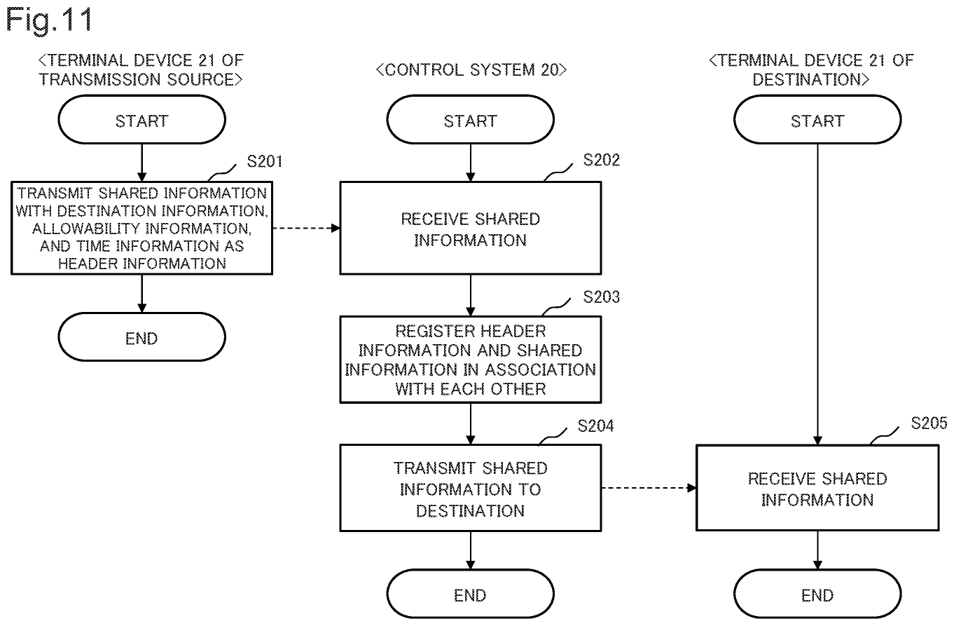

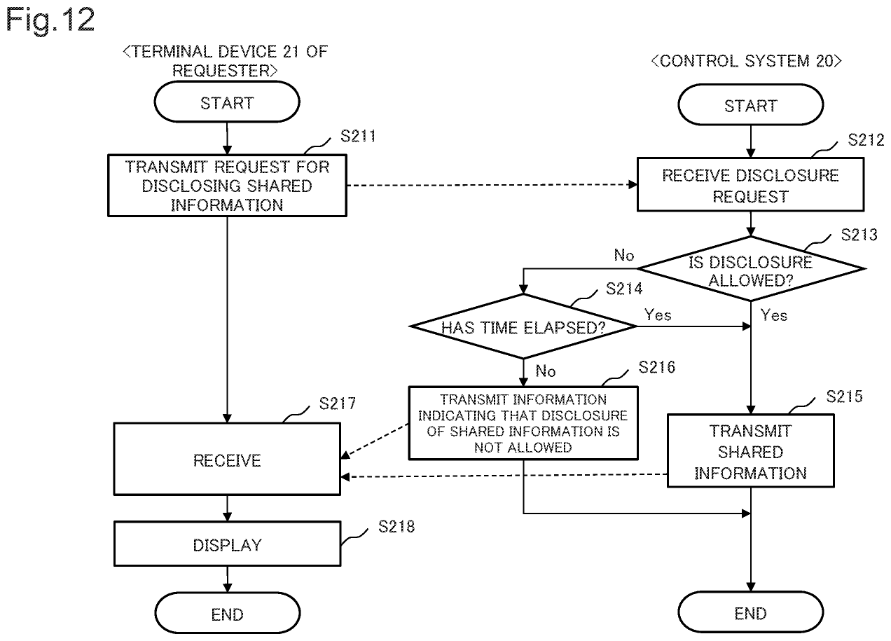

Next, an operation example of the control system 20 according to the second example embodiment will be described with reference to FIGS. 11 and 12.

FIG. 11 is a flowchart illustrating an operation example at the time of receiving shared information of the control system 20 according to the second example embodiment. The transmission source terminal device 21 transmits shared information to the control system 20 with the destination information, the allowability information, and the time information as header information (step S201). The shared information reception unit 201 receives the shared information (step S202). The registration unit 204 registers the header information and the shared information in the database 2000 in association with each other (step S203).

The shared information transmission unit 203 transmits the shared information to the destination indicated by the destination information included in the header information (step S204). The terminal device 21 of the destination receives the shared information (step S205).

As a result, the shared information created by the transmission source terminal device 21 is registered in the database 2000 and transmitted to the destination.

FIG. 12 is a flowchart illustrating an operation example at the time of receiving a request for disclosing the control system 20 according to the second example embodiment. The terminal device 21 transmits a request for disclosing the shared information to the control system 20 by the link information included in the shared information (step S211). More specifically, for example, in step S211, when the link information included in the shared information is clicked by the user's operation on the input device, the terminal device 21 transmits a request for disclosing the shared information as a link destination to the control system 20.

The control unit 202 receives the request for disclosing the shared information (step S212). Next, the control unit 202 determines whether the disclosure of the shared information is allowed (step S213). In step S213, for example, the control unit 202 refers to each piece of information associated with the shared information requested to be disclosed from the database 2000. Then, in a case where the requester is other than the destination and the transmission source (for example, the creator) of the shared information requested to be disclosed, the control unit 202 determines whether the allowability information of the shared information indicates that the disclosure is allowed. In a case where the requester is the destination or the transmission source (for example, the creator) of the shared information requested to be disclosed, the control unit 202 determines that the disclosure of the shared information is allowed (step S213: Yes), and proceeds to step S215.

When the disclosure of the shared information is not allowed (step S213: No), the control unit 202 determines whether a predetermined time indicated by the time information has elapsed since when the shared information reception unit 201 receives the shared information (step S214). When it is determined that the predetermined time has not elapsed (step S214: No), the control unit 202 causes the shared information transmission unit 203 to transmit information indicating that the disclosure of the shared information is not allowed to the requester. Then, the shared information transmission unit 203 transmits information indicating that the disclosure of the shared information is not allowed to the requester (step S216).

In a case where the disclosure of the shared information allowed (step S213: Yes) or in a case where it is determined that the predetermined time has elapsed (step S214: Yes), the control unit 202 causes the shared information transmission unit 203 to transmit the shared information to the requester. Then, the shared information transmission unit 203 transmits the shared information to the requester (step S215).

The terminal device 21 of the requester receives various types of information according to the disclosure request from the control system (step S217). In a case where the disclosure of the shared information is allowed, the terminal device 21 of the requester receives the shared information. In a case where the disclosure of the shared information is not allowed, the terminal device 21 of the requester receives information indicating that the disclosure of the shared information is not allowed.

Then, for example, the terminal device 21 of the requester displays the received information to a display device or the like of the terminal device 21 (step S218). In step S218, an example is described in which the terminal device 21 displays the received information on the display device of the terminal device 21, but the present invention is not limited thereto, and the received information may be output by voice to the audio output device of the terminal device 21, or the received information may be stored in the storage device of the terminal device 21.

As described above, in the second example embodiment, the control system 20 transmits the shared information to the requester in a case where the disclosure is allowed, and does not transmit the shared information to the requester in a case where the disclosure is not allowed. As a result, the control system 20 can control transmission of the shared information by the allowability information.

In a case where the disclosure is not allowed, the control system transmit information indicating that the disclosure is not allowed to the requester. As a result, the requester can grasp the reason why the access to the shared information has failed.

For example, it is not desirable from the viewpoint of security that information with which vulnerability being present in a specific device such as the terminal device 21 or another device can be identified, such as alert information or risk assessment information, is immediately disclosed. On the other hand, these pieces of information may be disclosed or may be better disclosed after the vulnerability is addressed. Therefore, in a case where the disclosure of the shared information is not allowed, when receiving the disclosure request, the control system 20 may control whether to disclose the shared information to the requester depending on the lapse of time from the reception of the shared information. Specifically, for example, in a case where the disclosure is not allowed, when receiving the disclosure request, the control system 20 disclose the shared information to the requester in a case where a predetermined time has elapsed since reception of the shared information, and does not disclose the shared information to the requester in a case where the predetermined time has not elapsed since reception of the shared information. As a result, the range of disclosure can be changed with the lapse of time. Therefore, it is possible to save the user's trouble. For example, it is possible to save the user's trouble as compared with a case where the user who creates the shared information gives permission of disclosure to other users or the like after the lapse of time. In a case where the disclosure of the shared information is not allowed, an example of the shared information in a case where the information is disclosed with the lapse of time or the like is not limited to the above-described example.

The description of each example embodiment ends. The example embodiments may be used in combination. For example, in each example embodiment, the control system may include part of each functional unit and information.

Each example embodiment is not limited to the above-described example, and various modifications can be made. The control system may be achieved by one device, or may be achieved by a plurality of devices (for example, a plurality of servers and the like) different for each piece of information or function. Specifically, for example, one terminal device 21 may include a functional unit of the control system 20 described in the second example embodiment.

In each example embodiment, each piece of information may include part of the information described above. Each piece of information may include information other than the above-described information. Each piece of information may be divided into a plurality of pieces of information in more detail. As described above, a method for achieving each piece of information is not particularly limited.

### (Computer Device)

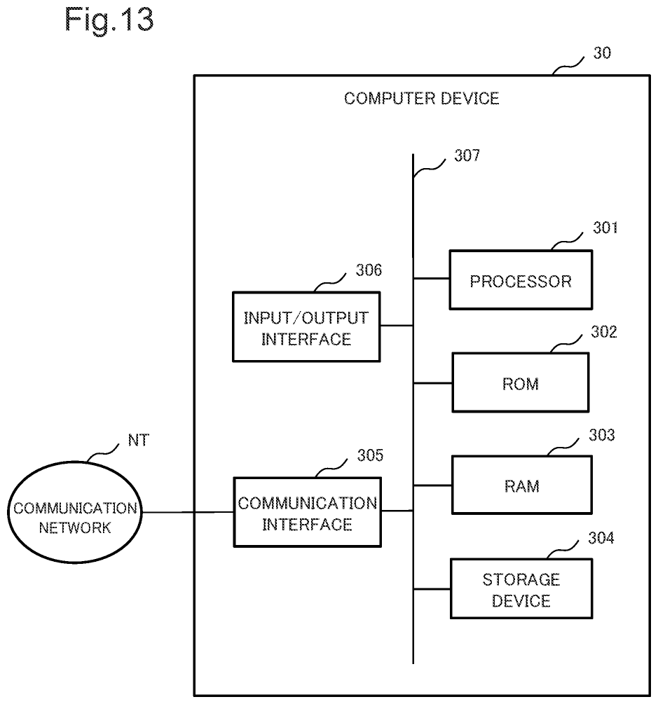

Next, a hardware configuration example in a case where the control system described in each example embodiment is implemented by a computer device will be described. FIG. 13 is an explanatory diagram illustrating a hardware configuration example of a computer device. Part or all of each device can also be achieved by using an any combination of a computer device 30 and the program as illustrated in FIG. 13, for example.

The computer device 30 includes, for example, a processor 301, a read only memory (ROM) 302, a random access memory (RAM) 303, a storage device 304, a communication interface 305, and an input/output interface 306. The components are connected via a bus 307.

The processor 301 controls the entire computer device 30. Examples of the processor 301 include a central processing unit (CPU), a digital signal processor (DSP), and the like. The number of processors 301 may be plural. The computer device 30 includes the ROM 302, the RAM 303, the storage device 304, and the like as storage units. Examples of the storage device 304 include a semiconductor memory such as a flash memory, a hard disk drive (HDD), a solid state drive (SSD), and the like. For example, the storage device 304 stores an operating system (OS) program, an application program, a program according to each example embodiment, and the like. Alternatively, the ROM 302 stores an application program, a program according to each example embodiment, and the like. Then, the RAM 303 is used as a work area of the processor 301.

The processor 301 loads a program stored in the storage device 304, the ROM 302, or the like. Then, the processor 301 executes each processing (each processing instruction) coded in the program. The processor 301 may download various programs via the communication network NT. The processor 301 functions as part or all of the computer device 30. Then, the processor 301 may execute processing or instructions in the flowchart illustrated based on the program.

The communication interface 305 is connected to a communication network NT such as a local area network (LAN) or a wide area network (WAN) through a wireless or wired communication line. The communication network NT may include a plurality of communication networks NT. As a result, the computer device 30 is connected to an external device or an external computer via the communication network NT. The communication interface 305 manages an interface between the communication network NT and the inside of the computer device 30. Then, the communication interface 305 controls an input/output of data from an external device or an external computer.

The input/output interface 306 is connected to at least one of an input device, an output device, and an input/output device. The connection method may be wireless or wired. Examples of the input device include a keyboard, a mouse, and a microphone. Examples of the output device include a display device, a lighting device, and a speaker that is an audio output device that outputs a voice. Examples of the input/output device include a touch panel display. The input device, the output device, the input/output device, and the like may be built in the computer device 30 or may be externally attached.

The hardware configuration of the computer device 30 is an example. The computer device 30 may have some components illustrated in FIG. 13. The computer device 30 may have components other than those illustrated in FIG. 13. For example, the computer device may include a drive device or the like. Then, the processor 301 may read a program or data stored in a recording medium attached to a drive device or the like into the RAM 303. Examples of the non-transitory tangible recording medium include an optical disk, a flexible disk, a magnetic optical disk, and a Universal Serial Bus (USB) memory. As described above, for example, the computer device 30 may include an input device such as a keyboard and a mouse. The computer device 30 may have an output device such as a display. The computer device 30 may include an input device, an output device, and an input/output device. The computer device 30 may include various sensors (not illustrated). The type of the sensor is not particularly limited.

This is the end of the description of the hardware configuration of the control system. There are various modifications of the method of achieving the control system. For example, the control system may be achieved by an any combination of a computer device and a program different for each component. A plurality of components included in the control system may be achieved by an any combination of one computer and a program.

Part or all of each component of the control system may be achieved by an application specific circuit. Part or all of the control system may be achieved by a general-purpose circuit including a processor such as a field programmable gate array (FPGA). Part or all of the control system may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

When part or all of each component of each device is achieved by a plurality of computer devices, circuits, and the like, the plurality of computer devices, circuits, and the like may be disposed in a centralized manner or in a distributed manner.

The control method described in each example embodiment is implemented by a computer device such as a control system. The control method is implemented by a computer device such as a control system executing a program prepared in advance. The program described in each example embodiment is recorded in a computer device readable recording medium such as an HDD, an SSD, a flexible disk, an optical disk, a flexible disk, a magnetic optical disk, or a USB memory. Then, the program is executed by being read from the recording medium by the computer device. The program may be distributed via the communication network NT.

Each component of the control system in each example embodiment described above may be achieved in hardware as a computer device. Alternatively, each component may be achieved by a computer device or firmware based on program control.

Although the present disclosure is described with reference to the example embodiments, the present disclosure is not limited to the example embodiments. The configuration and details of each of the present disclosure may include example embodiments to which various changes that can be grasped by those of ordinary skill in the art within the scope of the present disclosure are applied. The present disclosure may include the example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A control system including
a shared information reception means configured to receive destination information indicating a destination, allowability information indicating allowability of disclosure to a requester other than the destination, and shared information, and
a control means configured to control whether to disclose the shared information, wherein
when receiving a disclosure request for disclosing the shared information from a requester other than the destination, the control means discloses the shared information to the requester in a case where the disclosure is allowed, and does not disclose the shared information to the requester in a case where the disclosure is not allowed.

### (Supplementary Note 2)

The control system according to Supplementary Note 1, further including
a shared information transmission means configured to transmit the shared information to the destination.

### (Supplementary Note 3)

The control system according to Supplementary Note 2, wherein
the control means causes the shared information transmission means to transmit the shared information to the requester in a case where the disclosure is allowed, and does not cause the shared information transmission means to transmit the shared information to the requester in a case where the disclosure is not allowed.

### (Supplementary Note 4)

The control system according to Supplementary Note 3, wherein
the control means causes the shared information transmission means to transmit, to the requester, information indicating that the disclosure is not allowed in a case where the disclosure is not allowed.

### (Supplementary Note 5)

The control system according to any one of Supplementary Notes 1 to 4, further including
a registration means configured to register the destination information, the allowability information, and the shared information in association with each other.

### (Supplementary Note 6)

The control system according to any one of Supplementary Notes 1 to 5, wherein
in a case where the disclosure is not allowed, when receiving the disclosure request, the control means controls whether to disclose the shared information to the requester depending on a lapse of time from the reception of the shared information.

### (Supplementary Note 7)

The control system according to Supplementary Note 6, wherein
in a case where the disclosure is not allowed, the control means discloses the shared information to the requester when a predetermined time has elapsed since the reception of the shared information, and does not disclose the shared information to the requester when the predetermined time has not elapsed since the reception of the shared information.

### (Supplementary Note 8)

The control system according to Supplementary Note 7, wherein
the shared information reception means receives time information indicating the predetermined time together with the destination information, the allowability information, and the shared information in a case where the disclosure is not allowed.

### (Supplementary Note 9)

The control system according to any one of Supplementary Notes 6 to 8, wherein
the shared information is information with which vulnerability being present in a specific device can be identified.

(Supplementary Note 10) The control system according to Supplementary Note 8, wherein
the shared information reception means receives the shared information with the destination information, the allowability information, and the time information as header information.

### (Supplementary Note 11)

The control system according to any one of Supplementary Notes 1 to 8, wherein
the shared information with the destination information and the allowability information as header information is received.

### (Supplementary Note 12)

The control system according to any one of Supplementary Notes 1 to 6, wherein
the shared information is a software bill of materials.

### (Supplementary Note 13)

The control system according to any one of Supplementary Notes 1 to 11, wherein
the shared information is risk assessment information about a specific device.

### (Supplementary Note 14)

The control system according to any one of Supplementary Notes 1 to 11, wherein
the shared information is alert information about a specific device.

### (Supplementary Note 15)

A control method including
receiving destination information indicating a destination, allowability information indicating allowability of disclosure to a requester other than the destination, and shared information, and
controlling whether to disclose the shared information, wherein
when receiving a disclosure request for disclosing the shared information from a requester other than the destination, the controlling includes disclosing the shared information to the requester in a case where the disclosure is allowed, and not disclosing the shared information to the requester in a case where the disclosure is not allowed.

### (Supplementary Note 16)

A non-transitory computer-readable recording medium recording a program, the program causing a computer to execute the steps of
receiving destination information indicating a destination, allowability information indicating allowability of disclosure to a requester other than the destination, and shared information, and
controlling whether to disclose the shared information, wherein
when receiving a disclosure request for disclosing the shared information from a requester other than the destination, the controlling step includes disclosing the shared information to the requester in a case where the disclosure is allowed, and not disclosing the shared information to the requester in a case where the disclosure is not allowed.

### (Supplementary Note 17)

A program causing a computer to execute the steps of
receiving destination information indicating a destination, allowability information indicating allowability of disclosure to a requester other than the destination, and shared information, and
controlling whether to disclose the shared information, wherein
when receiving a disclosure request for disclosing the shared information from a requester other than the destination, the controlling step includes disclosing the shared information to the requester in a case where the disclosure is allowed, and not disclosing the shared information to the requester in a case where the disclosure is not allowed.

### REFERENCE SIGNS LIST

10, 20 control system
21, 21-1, 21-2, 21-3, 21-4 terminal device
30 computer device
101, 201 shared information reception unit
102, 202 control unit
203 shared information transmission unit
204 registration unit
301 processor
302 ROM
303 RAM
304 storage device
305 communication interface
306 input/output interface
307 bus
2000 database
A user
B user
C user
D user
H alert information
J shared information
X shared information
Y shared information
Z shared information
NT communication network

What is claimed is:

1. A control system comprising:
a memory storing instructions; and
at least one processor configured to execute the instructions to:
receive destination information indicating a destination, allowability information indicating allowability of disclosure to a requester other than the destination, and shared information;
control whether to disclose the shared information; and
when receiving a disclosure request for disclosing the shared information from a requester other than the destination, disclose the shared information to the requester in a case where the disclosure is allowed, and not disclose the shared information to the requester in a case where the disclosure is not allowed.

2. The control system according to claim 1, wherein the at least one processor is further configured to execute the instructions to:
transmit the shared information to the destination.

3. The control system according to claim 2, wherein the at least one processor is further configured to execute the instructions to:
transmit the shared information to the requester in a case where the disclosure is allowed, and not transmit the shared information to the requester in a case where the disclosure is not allowed.

4. The control system according to claim 3, wherein the at least one processor is further configured to execute the instructions to:
transmit, to the requester, information indicating that the disclosure is not allowed in a case where the disclosure is not allowed.

5. The control system according to claim 1, wherein the at least one processor is further configured to execute the instructions to:
register the destination information, the allowability information, and the shared information in association with each other.

6. The control system according to claim 1, wherein the at least one processor is further configured to execute the instructions to:
in a case where the disclosure is not allowed, when receiving the disclosure request, control whether to disclose the shared information to the requester depending on a lapse of time from the reception of the shared information.

7. The control system according to claim 6, wherein the at least one processor is further configured to execute the instructions to:
in a case where the disclosure is not allowed, disclose the shared information to the requester when a predetermined time has elapsed since the reception of the shared information, and not disclose the shared information to the requester when the predetermined time has not elapsed since the reception of the shared information.

8. The control system according to claim 7, wherein the at least one processor is further configured to execute the instructions to:
receive time information indicating the predetermined time together with the destination information, the allowability information, and the shared information in a case where the disclosure is not allowed.

9. The control system according to claim 6, wherein
the shared information is information with which vulnerability being present in a specific device can be identified.

10. The control system according to claim 8, wherein the at least one processor is further configured to execute the instructions to:
receive the shared information with the destination information, the allowability information, and the time information as header information.

11. The control system according to claim 1, wherein the at least one processor is further configured to execute the instructions to:
receive the shared information with the destination information and the allowability information as header information.

12. The control system according to claim 1, wherein
the shared information is a software bill of materials.

13. The control system according to claim 1, wherein
the shared information is risk assessment information about a specific device.

14. The control system according to claim 1, wherein
the shared information is alert information about a specific device.

15. A control method comprising:
receiving destination information indicating a destination, allowability information indicating allowability of disclosure to a requester other than the destination, and shared information; and
controlling whether to disclose the shared information, wherein
when receiving a disclosure request for disclosing the shared information from a requester other than the destination, the controlling includes disclosing the shared information to the requester in a case where the disclosure is allowed, and not disclosing the shared information to the requester in a case where the disclosure is not allowed.

16. A non-transitory computer-readable recording medium recording a program, the program causing a computer to execute the steps of:
receiving destination information indicating a destination, allowability information indicating allowability of disclosure to a requester other than the destination, and shared information; and
controlling whether to disclose the shared information, wherein
when receiving a disclosure request for disclosing the shared information from a requester other than the destination, the controlling step includes disclosing the shared information to the requester in a case where the disclosure is allowed, and not disclosing the shared information to the requester in a case where the disclosure is not allowed.
